(19) United States
(12) Patent Application Publication
(10) Pub. No.: US 2018/0092230 A1
(43) Pub. Date: Mar. 29, 2018

(54) COMBINATION MODULE ASSEMBLY

(71) Applicants: YOUNG-CHANG HSU, Taichung City (TW); Joyruby International Co., Ltd., Taichung City (TW)

(72) Inventor: YOUNG-CHANG HSU, Taichung City (TW)

(21) Appl. No.: 15/280,946

(22) Filed: Sep. 29, 2016

(51) Int. Cl. H05K 5/02; H05K 5/03

(52) U.S. Cl. CPC H05K 5/0256; H05K 5/0204; H05K 5/03

(57) ABSTRACT

A combination module assembly includes at least one module assembly provided with a main body. Two ends of the main body are provided with a first connecting end and a second connecting end, respectively. The first connecting end and the second connecting end are provided with corresponding connecting members, respectively, so as to be optionally connected with one of the first connecting end and the second connecting end of another module assembly. With such configuration, a plurality of module assemblies with different functions are combined into a whole for facilitating the storing, carrying and usage of the present invention.

### BACKGROUND OF THE INVENTION

### 1. Field of the Invention

The present invention relates to combination module structures. The module assemblies are allowed to be 3C (Computers/Communications/Consumer Electronics) products and relative peripheral apparatuses thereof. More particularly, the present invention relates to a combination module assembly capable of integrally combining multiple module assemblies with different functions for facilitating purposes of storing, carrying and using.

### 2. Description of the Related Art

In modern life of people nowadays, the role of 3C (Computers/Communications/Consumer Electronics) products apparently becomes more and more important. Besides portable cellular phones and tablets, peripherals such as mobile power packs, chargers, Bluetooth speakers, or USB connecting wires are all necessary equipment.

Therefore, user needs to apply different storing measures to carry the aforementioned peripherals. The most commonly used measure is a backpack or a storage bag, in where all the peripherals are gathered together. However, the connection wires or power cable of different peripherals usually tangles in the bag. As a result, the convenience of usage of the products is not met, and the metal cores of wires are easily damaged or broken due to the tangling, shortening the service life of the products.

In addition, due to the fact that all the products are stored in the bag, the user is unable to figure out whether all the products are retrieved after usage. As a result, some of the peripherals are not stored in the bag after usage and eventually lost.

### SUMMARY OF THE INVENTION

For improving the aforementioned issues, an embodiment of the present invention discloses a combination module assembly, wherein different module assemblies with different functions are able to be combined into a whole for facilitating the purposes of storing, carrying and using.

For achieving the objectives above, an embodiment of the present invention provides a combination module assembly, comprising:

at least one module assembly including a main body, two ends of the main body being a first connecting end and a second connecting end, the first connecting end and the second connecting end provided with corresponding connecting members, respectively, so as to be optionally connected with one of the first connecting end and the second connecting end of another module assembly.

With such configuration, the user is allowed to choose a plurality of module assemblies and connect the module assemblies in series into a whole, such that the whole combination of the module assemblies are easy to be stored, carried, or put into a back pack. Also, the user is able to know if all the module assemblies with different functions are retrieved after usage by simply seeing. The module assemblies are prevented from being put in different portion of the back pack, so as to prevent the issues of reaching and accidentally losing different module assemblies.

### BRIEF DESCRIPTION OF THE DRAWINGS

FIG. 1 is an exploded view of a variety of module assembly embodiments in accordance with the present invention.

FIG. 2 is a perspective view of the combination module assemblies of FIG. 1.

FIG. 3 is a perspective view of a charger embodiment in accordance with the present invention illustrating the operation status of the charger.

FIG. 4 is a sectional view of a wire rewinder embodiment in accordance with the present invention.

FIG. 5 is a first schematic view illustrating the outer shell replacing process.

FIG. 6 is a second schematic view illustrating the outer shell replacing process.

FIG. 7 is a perspective view of a mini projector embodiment in accordance with the present invention illustrating the operation status of the mini projector.

FIG. 8 is a perspective view of a flashlight embodiment in accordance with the present invention illustrating the operation status of the flashlight.

FIG. 9 is a perspective view of a universal extension socket embodiment in accordance with the present invention illustrating the operation status of the universal extension socket.

FIG. 10 is a camcorder embodiment in accordance with the present invention illustrating the operation status of the camcorder.

FIG. 11 is a conductive juncture embodiment in accordance with the present invention illustrating the operation status of the conductive junctures.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

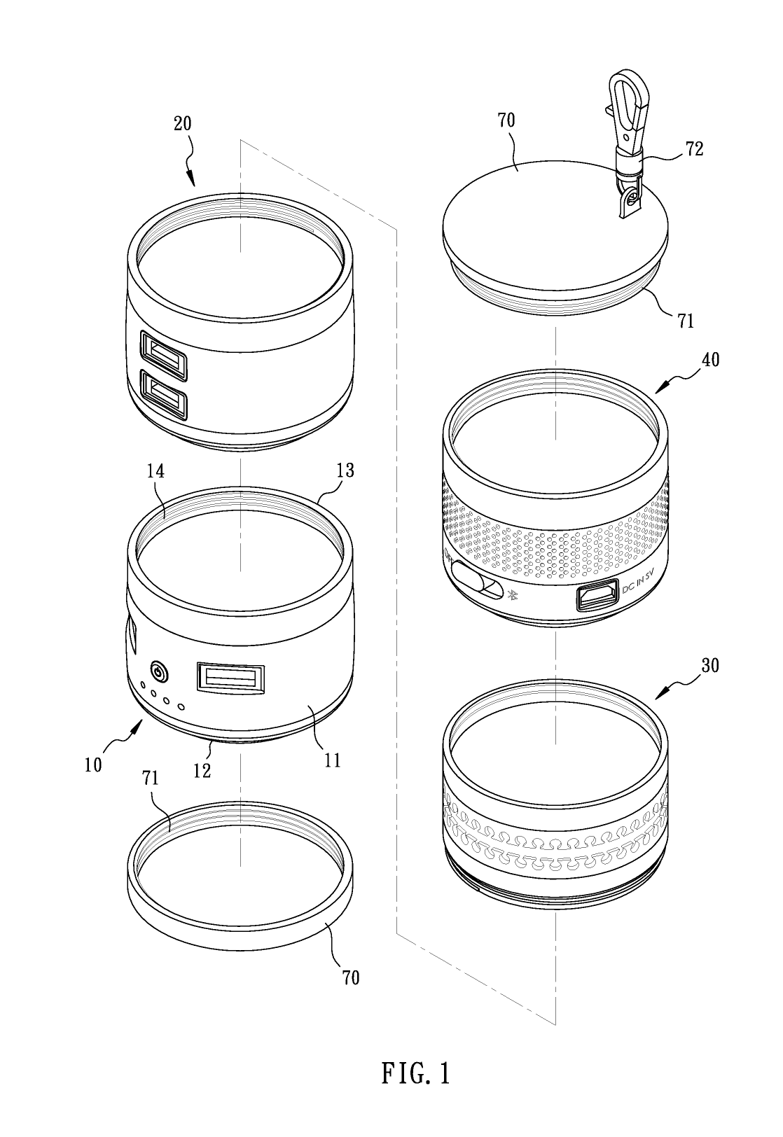

Referring to FIG. 1 to FIG. 10, an embodiment of the present invention comprises at least one module assembly 10. The module assembly 10 includes a main body 11, which is able to be formed into different shapes such as a column shape or a rectangular shape. Two ends of the main body 11 are provided with a first connecting end 12 and a second connecting end 13, wherein the first connecting end 12 and the second connecting end 13 are provided with a corresponding connecting member 14. Thus, the first connecting end 12 and the second connecting end 13 are allowed to be optionally connecting with one of the first connecting end 12 and the second connecting end 13 disposed on another module assembly 10.

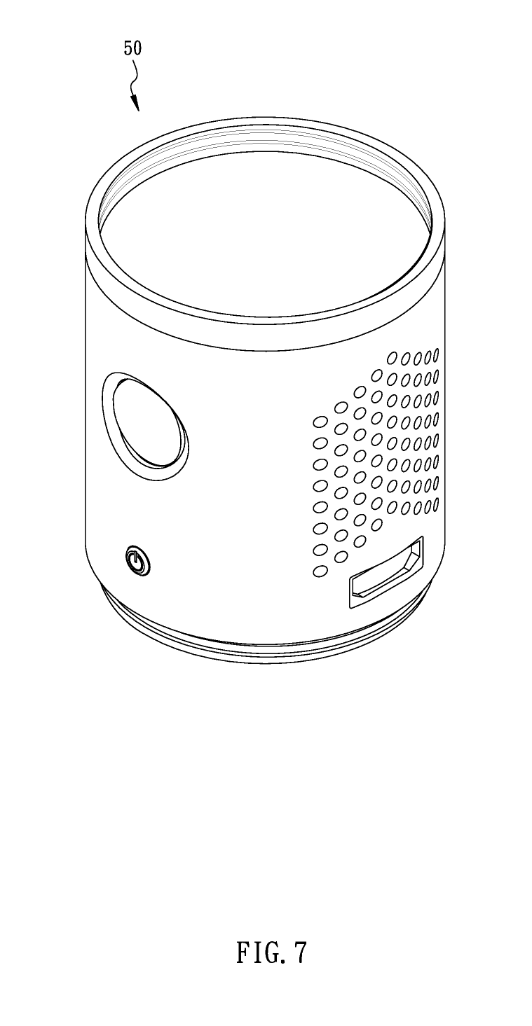

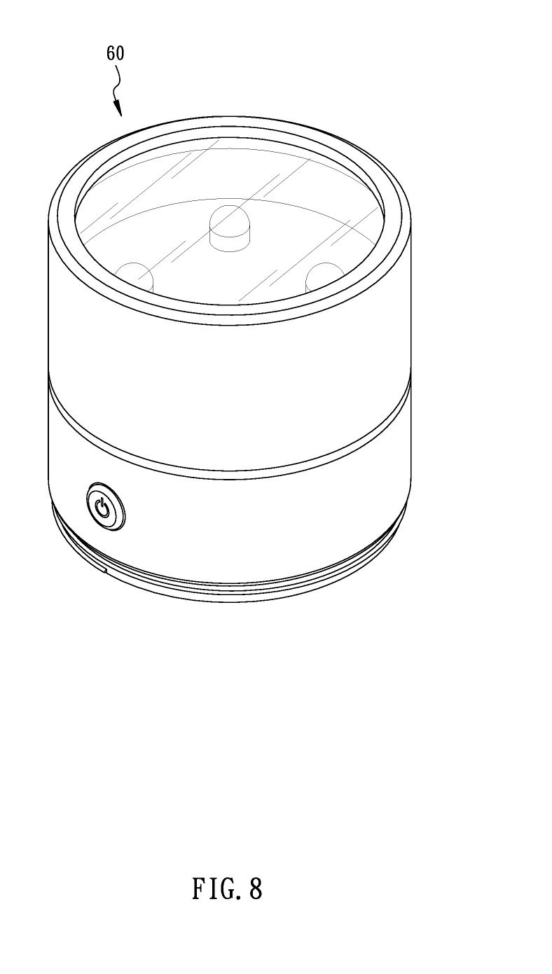

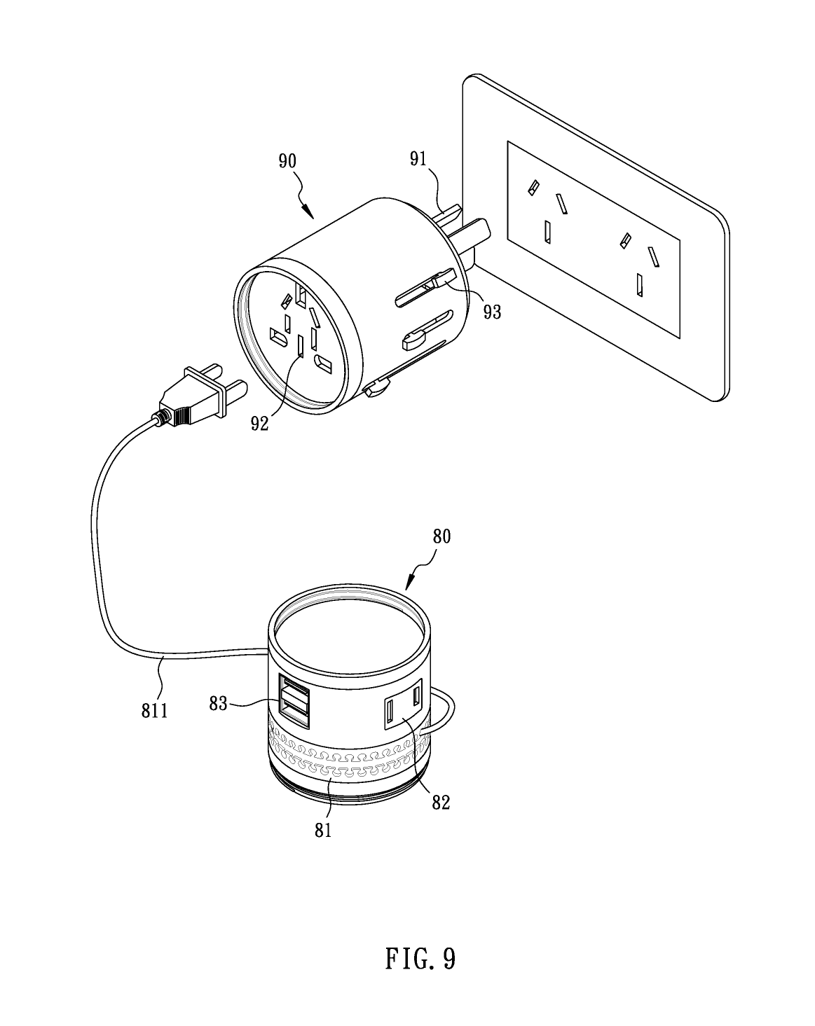

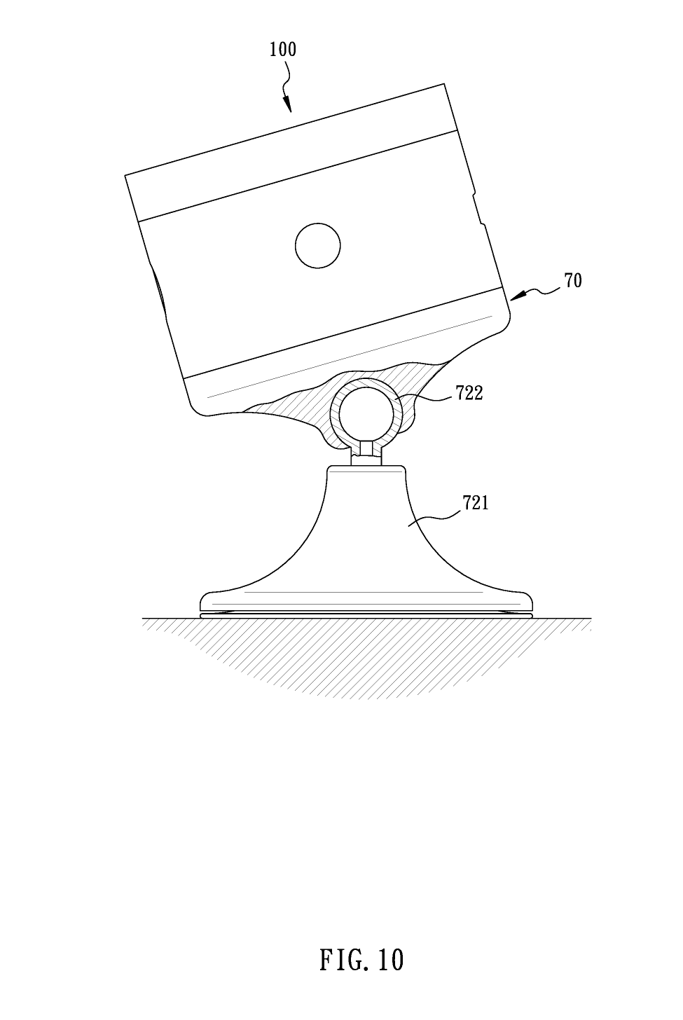

Preferably, the module assembly 10 is allowed to be at least one of a mobile power pack 10, charger 20, wire rewinder 30, Bluetooth speaker 40, mini projector 50 (as shown in FIG. 7), flashlight 60 (as shown in FIG. 8), universal extension socket 80 (as shown in FIG. 9), universal plug 90, microphone, multi-media player, wireless charger, or camcorder 100 (as shown in FIG. 10).

In another embodiment, the connecting member 14 of the first connecting end 12 of the module assembly 10 is formed into a male thread, and the connecting member 14 of the second connecting end 13 is formed into a female thread.

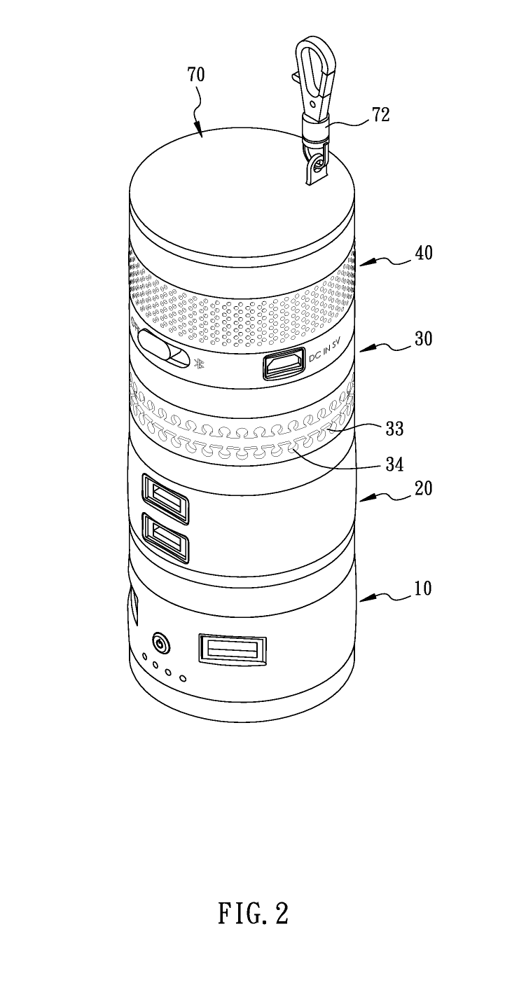

By use of the male/female thread of each module assembly 10, the user is able to combine plural module assemblies 10 with different functions. Referring to FIG. 1 and FIG. 2, the user is allowed to screwedly mount the male/female thread on the second connecting end 13 of the mobile power pack 10 and the male/female thread on the first connecting end 12 of the charger 20 together, so as to form the mobile power pack 10 and the charger 20 into a whole. Similarly, when the user needs to carry or use the module assemblies 10 with different functions, such as a wire rewinder 30 and a Bluetooth speaker 40, the module assemblies 10 are screwedly assembled in series into a whole. With such configuration, the whole combination of plural module assemblies 10 meets the convenience of being stored, carried, or put into a back pack, so as to prevent the module assemblies 10 with different functions from being put into different portions of the back pack, so as to resolve the issues of difficulty reaching and accidentally losing different module assemblies 10.

Also, an embodiment of the present invention further comprises a lid 70 which is movably combined to one of the first connecting end 12 and second connecting end. In addition, the lid 70 is allowed to be at least a top lid or a bottom lid. As shown by FIG. 1 and FIG. 2, the lid 70 is provided with a combining structure 71 (such as male thread) corresponding to the connecting member 14 of the second connecting end 13, such that the lid 70 is applied as a top cover. Also, the lid 70 is provided with a movable fixing member 72. The movable fixing member 72 is allowed to be a movable hook, cleat, or clamp ring, whereby the present invention is able to be hooked onto the back pack or stored in other suitable places. Also, the lid 70 further prevents the connecting member 14 from being depressed or deformed due to collision. Alternatively, a housing space is provided in the lid 70 for storing memory card or other objects needed.

In other embodiments, the connecting member 14 is allowed to be at least one of screwing member, magnetic suction member, embedding member, or tenon member.

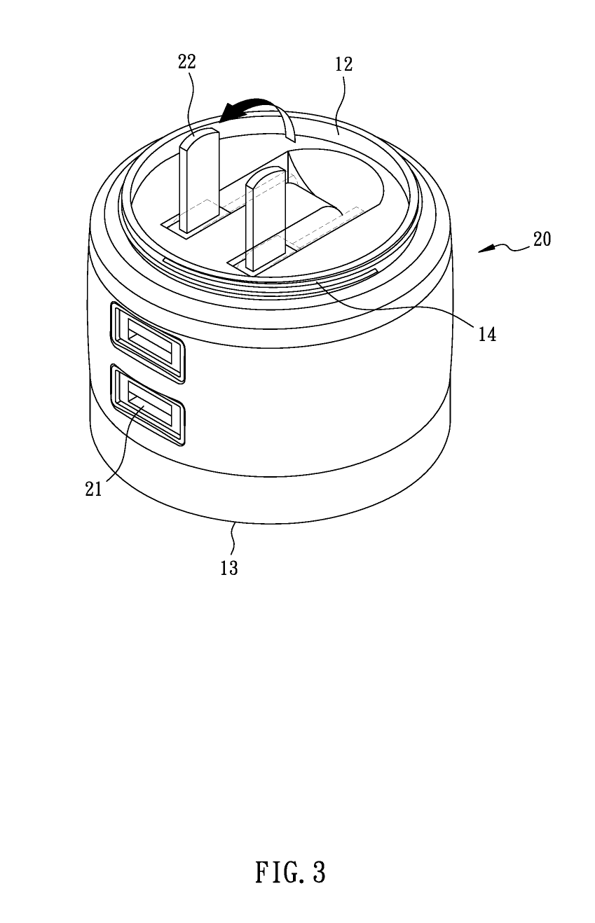

The surface of the main body 11 is allowed to be provided with buttons, displaying lights, or USB port, depending on the different functions achieved by the different module assemblies 10. As shown in FIG. 3 illustrating the charger 20, the surface of the main body 11 is provided with multiple USB ports 21 for electricity outputting, and the first connecting end 12 is provided with a foldable plug 22.

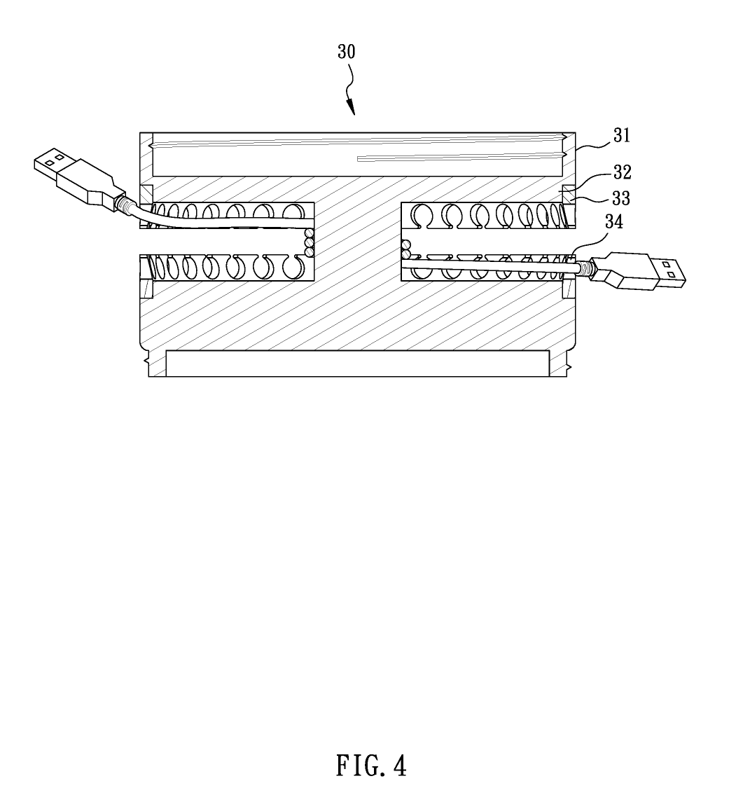

Referring to FIG. 4, the main body 31 of the wire rewinder 30 is provided with a rewinder groove 32, and the opening of the rewinder groove 32 has at least one resilient plate 33. The resilient plate 33 herein refers to a flat plate member with no notches; alternatively, the resilient plate 33 is provided with at least one notch 34. The rewinder groove 32 allows at least one wire to be rewinded and contained therein, while the wire is able to be a common USB wire, earphone wire, Lightning wire, HDMI wire, or AV wire. The resilient plate 33 provides a resilient force to wrap and house the USB wire in the rewinder groove 32, so as to prevent the wire from escaping from the rewinder groove 32. Also, the notch 34 on the resilient plate 33 engages and fixes a head portion of the wire, beneficial for the user to take and apply the wire. Moreover, as shown by FIG. 9, a same rewinder groove 81 is also applicable to a universal extension socket 80, wherein the outer periphery of the universal extension socket 80 has plural sockets 82 or USB output ports 83 and is electrically coupled with an extension wire 811 of the rewinder groove 81. The extension wire 811 is movably inserted into a universal plug 90, and the universal plug 90 is provided with at least a set of input plugs 91 and at least a set of output sockets 92. The output socket 92 is suitable for various standards of plugs. A plurality of switch buttons 93 are disposed on a lateral side of the universal plug 90, so as to optionally put in or put out different input plugs 91 according to different applicable plug standards of different countries. The universal extension socket 80 together with the universal plug 90 are suitable for various plugs and electronics in different countries, and the amount of the sockets is able to be increased to provide the applicability to more electronics. Further, the sockets 82 that are disposed on the outer periphery of the universal extension socket 80 minimizes the interference between the adapters of different electronics, so as to minimizing the volume of the universal extension socket 80 and facilitating the portability.

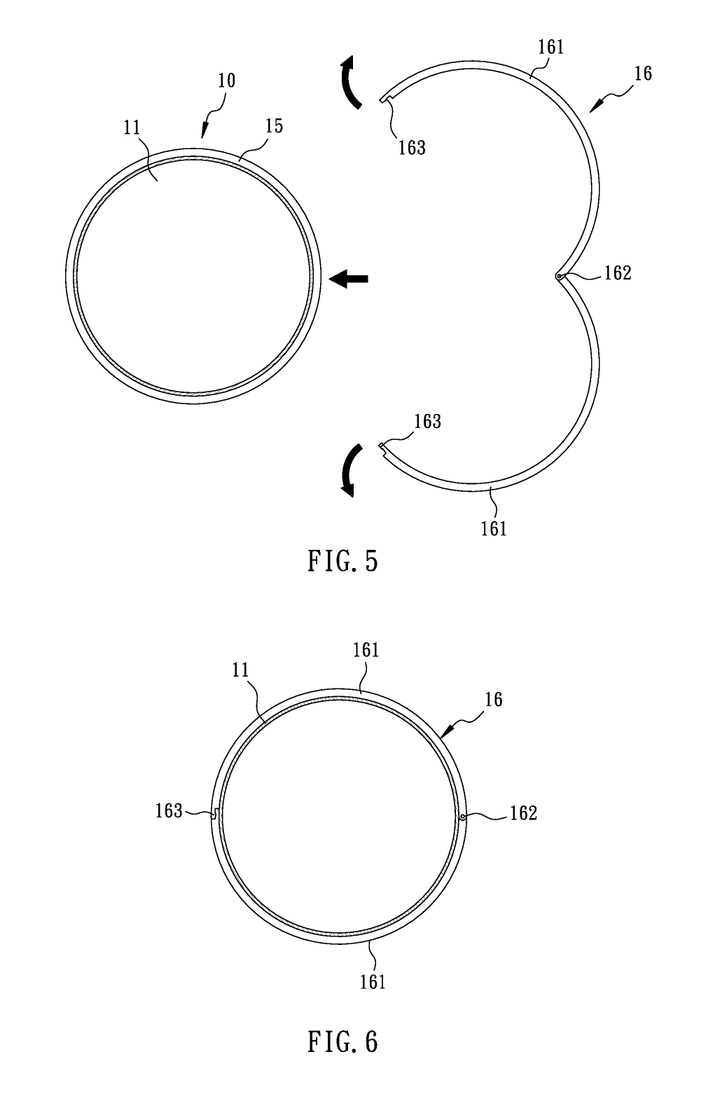

As shown by FIG. 5, the surface of the main body 11 is concavely provided with an engaging groove 15 where a panel member 16 is movably engaged. For example, the main body 11 is formed in a column shape, and the panel member 16 is formed of two semi-column outer shells 161. The two outer shells 161 are pivotally combined to each other by a pivotal portion 162, with the other ends thereof provided with two corresponding coupling members 163, such that the outer shells 161 are able to movably clamp the main body 11 (as shown by FIG. 6). According to the types of the module assemblies 10, the panel members 16 are able to be pre-provided with openings for exposing the operation buttons or USB ports and facilitating the subsequent usages. Also, the panel members 16 are able to be manufactured with different colors, patters, or designs, not only preventing the main body 11 from scrapes and damages due to collision, but also enhancing the individuality and a variety of personal styles.

In another embodiment, the panel member 16 is an outer shell formed of a resilient material, such as a sleeve made of silica gel material, so as to be movably mounted around the main body 11 by use of the resilient property thereof, thereby protecting the main body 11 from damage due to collision.

Based on the functional demands upon the product, a connecting member 14 is optionally disposed on one of the first connecting end 12 and the second connecting end 13 of the main body 11, with the other end being as a functional end. Referring to the mini projector 50 shown in FIG. 7, the second connecting end 13 is provided with a projecting camera. Referring to the flashlight 60 shown in FIG. 8, the second connecting end 13 is provided with at least one illuminating member.

The movable fixing member 72 of the lid 70, besides a movable hook, cleat, and clamp ring, is also allowed to be a magnetic suction member, cradle head connector, screwing member, or suction pad member, so as to be fastened on a platform or other object such as a tripod. Referring to the example of a suction pad member 721 shown in FIG. 10, the lid 70 is able to be installed with a camcorder 100. By use of the suction pad member 721, the camcorder 100 adheres to a smooth face in a manner of suction for facilitating a web cam communication, photo shooting, or being used as an event data recorder. Also, a rotatable joint mechanism 722 is disposed between the lid 70 and the suction pad member 721 (or the magnetic suction member, cradle head connector, or screwing member applied), thereby facilitating the adjustment of the recording angle.

The module assemblies 10 are not only able to be used alone, but also able to be used in collocation for meeting different application environment. For example in an entertainment application, an audio is formed by the simple mobile power pack 10, the Bluetooth speaker 40, and the cellular phone or a tablet; further with the mini projector 50, a portable video and audio apparatus is achieved; when a microphone or a multi-media player is added, a KTV audio/video combination is formed. For example in a commercial application, the camcorder 100 with a microphone and the Bluetooth speaker 40 are applicable for facilitating a web cam conference. For example in a traveling application, the mobile power pack 10, the charger 20, the universal extension socket 80, and the universal plug 90 facilitate the usage of various types of electronics, such that the application of the present invention is further enhanced.

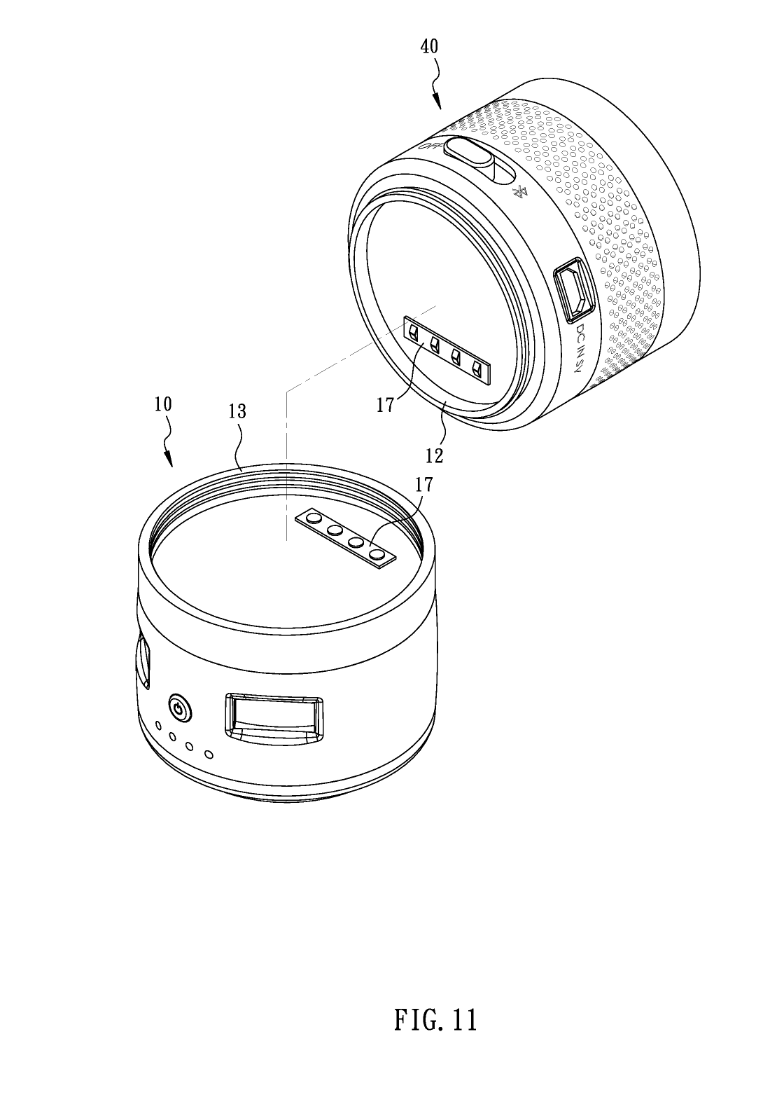

Furthermore, as shown by FIG. 11, the first connecting end 12 and the second connecting end 13 of each two neighboring module assemblies 10 are provided with plural corresponding conductive junctures 17, respectively. The conductive junctures 17 are formed of metal spring plate and metal sheet, so as to facilitate electricity and signal transmission. Referring to an example of the mobile power pack 10 and the Bluetooth speaker 40, when the second connecting end 13 of the mobile power pack 10 is connected with the first connecting end 12 of the Bluetooth speaker 40, the conductive junctures 17 are conductively connected by the resilient contact therebetween, such that the mobile power pack 10 provides the electricity needed by the Bluetooth speaker 40. In other possible embodiments, such conductive connection is allowed to be used for facilitating transmission of digital data, such as image, music, and photograph.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A combination module assembly, comprising:
at least one module assembly including a main body, two ends of the main body being a first connecting end and a second connecting end, respectively, the first connecting end and the second connecting end provided with corresponding connecting members, respectively, so as to be optionally connected with one of the first connecting end and the second connecting end of another module assembly.

2. The combination module assembly of claim 1, wherein the connecting end of the first connecting end formed as a male thread, and the connecting end of the second connecting end formed as a female thread.

3. The combination module assembly of claim 1, wherein the connecting member is chosen from at least one of a group consisting of a screwing member, a magnetic suction member, an embedding member, and a tenon member.

4. The combination module assembly of claim 1, wherein the module assembly is chosen from at least one of a group consisting of a charger, a mobile power pack, a wire rewinder, a Bluetooth speaker, a mini projector, a flashlight, a microphone, a multi-media player, a camcorder, a wireless charger, a universal plug, and a universal extension socket.

5. The combination module assembly of claim 1, wherein the main body includes a rewinder groove, and an opening of the rewinder groove is provided with at least one resilient plate.

6. The combination module assembly of claim 5, wherein the resilient plate is provided with at least one notch.

7. The combination module assembly of claim 1, wherein a surface of the main body is concavely provided with an engaging groove, and a panel member is movably engaged with the engaging groove, with the main body formed as a column shape, and the panel member formed of two semi-column outer shells, wherein one end of the two outer shells are pivotally combined to each other by a pivotal portion, and the other end of the two outer shells are provided with two corresponding coupling members, such that the outer shells movably clamp the main body.

8. The combination module assembly of claim 1, wherein a surface of the main body is concavely provided with an engaging groove, and a panel member is movably engaged with the engaging groove, wherein the panel member is an outer shell formed of a resilient material.

9. The combination module assembly of claim 1, further comprising a lid, which is movably combined to one of the first connecting end and the second connecting end.

10. The combination module assembly of claim 9, wherein the lid is provided with a movable fixing member, and the movable fixing member is chosen from at least one of the group consisting of a movable hook, a cleat, a clamp ring, a magnetic suction member, a cradle head connector, a screwing member, and a suction pad member.

11. The combination module assembly of claim 1, wherein the first connecting end and the second connecting end on two ends of the main body are provided with plural conductive junctures, respectively.
